(19) United States
(12) Patent Application Publication
(10) Pub. No.: US 2008/0212687 A1
(43) Pub. Date: Sep. 4, 2008

(54) High accurate subspace extension of phase correlation for global motion estimation

(75) Inventor: Ming-Chang Liu, San Jose, CA (US)

Correspondence Address: HAVERSTOCK & OWENS LLP, 162 N WOLFE ROAD, SUNNYVALE, CA, 94086, US

(73) Assignee: Sony Corporation and Sony Electronics Inc.

(21) Appl. No.: 11/713,254

(22) Filed: Mar. 2, 2007

(51) Int. Cl. H04N 7/00

(52) U.S. Cl. 375/240.26; 375/E07.026

(57) ABSTRACT

A method for achieving high sub-unit accuracy during global motion estimation of sequential video frame images is described herein. The method estimates the global motion using an existing phase-correlation approach, and further refines it to a sub-unit level using the neighborhood values of the phase correlation surface peak The method determines the sub-unit displacement direction by examining the signs of the peak of phase correlation surface and its two nearest neighbors. The method determines the sub-unit displacement magnitude by applying the ratio of associated phase correlation values to a 5^{th}-order polynomial function. The method then computes the actual motion by adding the sub-unit displacement value to the global motion value as calculated by the phase-correlation approach.

### FIELD OF THE INVENTION

The present invention relates to the field of video motion estimation. More specifically, the present invention relates to global video motion estimation using phase correlation.

### BACKGROUND OF THE INVENTION

In the digital era, many personal content videos have been transferred to a digital format for storage. There is a strong need to improve picture quality in these videos. Information of temporal relations (motion information) between video frames plays a very important role for such a quality improving process.

Personal content videos captured by a camcorder commonly contain uncomfortable vibrations due to hand shaking or unwanted camera movement. In order to stabilize these jittering videos for better viewing experiences, it is necessary to identify these camera motions, also referred to as global motion. Since human vision is very sensitive to small picture vibrations on scaling, rotation and translation, an accurate global motion is essential for this digital stabilization to work well. However, the existing algorithms for global motion estimation in general either are not accurate enough, are not robust to noise or illumination variation, can only cope with simple/ideal cases or require heavy computation. There is a need to estimate global motion accurately at the sub-pel level without introducing extra computational load.

Iterative block matching, optical flow approaches or phase correlation approaches have been proposed to improve robustness of the noise or illumination change. However, they need to interpolate data to achieve sub-pel accuracy, which increases computational load to several folds. Although simple formulas have been suggested using certain assumptions, these formulas only work at simple or special cases but are not accurate enough for general situations.

### SUMMARY OF THE INVENTION

A method of achieving high sub-unit accuracy during global motion estimation of sequential video frame images is described herein. The method estimates the global motion using an existing phase-correlation approach, and further refines it to a sub-unit level using the neighborhood values of the phase correlation surface peak. The method determines the sub-unit displacement direction by examining the signs of the peak of phase correlation surface and its two nearest neighbors. The method determines the sub-unit displacement magnitude by applying the ratio of associated phase correlation values to a 5^{th}-order polynomial function. The method then computes the actual motion by adding the sub-unit displacement value to the global motion value as calculated by the phase-correlation approach.

In one aspect, a method of refining global motion estimation comprises determining a sub-unit displacement direction by examining signs of a peak phase correlation and two neighboring phase correlation values and determining a sub-unit displacement magnitude by applying a polynomial function. Determining a sub-unit displacement direction by examining signs of the peak phase correlation and the two neighboring phase correlation values further comprises determining a category based on the signs of the peak phase correlation and the two neighboring phase correlation value values. The category is selected from the group consisting of a first category, a second category and a third category, further wherein the first category includes a positive peak phase correlation and two negative neighboring phase correlation values, the second category includes a positive peak phase correlation and two positive neighboring phase correlation values, and the third category includes a positive peak phase correlation and a positive neighboring phase correlation value and a negative neighboring phase correlation value. An actual peak position is located at a peak location when in the first category. Alternatively, an actual peak position is located between a peak location and a first neighboring value of the two neighboring values when in the second category, if the phase correlation value of the first neighboring value of the two neighboring values is greater than a second neighboring value of the two neighboring values, and wherein the actual peak position is located between the peak location and the second neighboring value of the two neighboring values when in the second category, if the phase correlation value of the first neighboring value of the two neighboring values is less than the second neighboring value of the two neighboring values, and wherein the actual peak position is located at the peak location when in the second category, if the phase correlation value of the first neighboring value of the two neighboring values is equal to the second neighboring value of the two neighboring values. Alternatively, the actual peak position is located between a peak location and a first neighboring value of the two neighboring values when in the third category and if the phase correlation value of the first neighboring value of the two neighboring values is positive, and wherein the actual peak position is located between the peak location and a second neighboring value of the two neighboring values when in the third category and if the phase correlation value of the second neighboring value of the two neighboring values is positive.

In another aspect, a method of estimating global motion in a video comprises determining a global motion estimation using a common phase correlation approach, including determining a peak location, refining the global motion estimation by determining a sub-unit displacement at a sub-unit level using the peak location and two neighboring values, wherein refining the global motion estimation comprises determining a sub-unit displacement direction by examining signs of a peak phase correlation and two neighboring phase correlation values and determining a sub-unit displacement magnitude by applying a polynomial function and computing the global motion by adding the sub-unit displacement to the global motion estimation. Determining a sub-unit displacement direction by examining signs of the peak phase correlation and the two neighboring phase correlation values further comprises determining a category based on the signs of the peak phase correlation and the two neighboring phase correlation values. The category is selected from the group consisting of a first category, a second category and a third category, further wherein the first category includes a positive peak phase correlation and two negative neighboring phase correlation values, the second category includes a positive peak phase correlation and two positive neighboring phase correlation values, and the third category includes a positive peak phase correlation and a positive neighboring phase correlation value and a negative neighboring phase correlation value. An actual peak position is located at the peak location when in the first category. Alternatively, an actual peak position is located between the peak location and a first neighboring value of the two neighboring values when in the second category, if the phase correlation value of the first neighboring value of the two neighboring values is greater than a second neighboring value of the two neighboring values, and wherein the actual peak position is located between the peak location and the second neighboring value of the two neighboring values when in the second category, if the phase correlation value of the first neighboring value of the two neighboring values is less than the second neighboring value of the two neighboring values, and wherein the actual peak position is located at the peak location when in the second category, if the phase correlation value of the first neighboring value of the two neighboring values is equal to the second neighboring value of the two neighboring values. Alternatively, an actual peak position is located between the peak location and a first neighboring value of the two neighboring values when in the third category and if the phase correlation value of the first neighboring value of the two neighboring values is positive, and wherein the actual peak position is located between the peak location and a second neighboring value of the two neighboring values when in the third category and if the phase correlation value of the second neighboring value of the two neighboring values is positive.

In another aspect, an apparatus for implementing global motion estimation in a video comprises a determining module for determining a global motion estimation using a common phase correlation approach, including determining a peak location, a refining module for refining the global motion estimation by determining a sub-unit displacement at a sub-unit level using the peak location and two neighboring values, wherein refining the global motion estimation comprises determining a sub-unit displacement direction by examining signs of a peak phase correlation and two neighboring phase correlation values and determining a sub-unit displacement magnitude by applying a polynomial function and a computing module for computing the global motion by adding the sub-unit displacement to the global motion estimation. Determining a sub-unit displacement direction by examining signs of the peak phase correlation and the two neighboring phase correlation values further comprises determining a category based on the signs of the peak phase correlation and the two neighboring phase correlation values. The category is selected from the group consisting of a first category, a second category and a third category, further wherein the first category includes a positive peak phase correlation and two negative neighboring phase correlation values, the second category includes a positive peak phase correlation and two positive neighboring phase correlation values, and the third category includes a positive peak phase correlation and a positive neighboring phase correlation value and a negative neighboring phase correlation value. An actual peak position is located at the peak location when in the first category. Alternatively, an actual peak position is located between the peak location and a first neighboring value of the two neighboring values when in the second category, if the phase correlation value of the first neighboring value of the two neighboring values is greater than a second neighboring value of the two neighboring values, and wherein the actual peak position is located between the peak location and the second neighboring value of the two neighboring values when in the second category, if the phase correlation value of the first neighboring value of the two neighboring values is less than the second neighboring value of the two neighboring values, and wherein the actual peak position is located at the peak location when in the second category, if the phase correlation value of the first neighboring value of the two neighboring values is equal to the second neighboring value of the two neighboring values. Alternatively, an actual peak position is located between the peak location and a first neighboring value of the two neighboring values when in the third category and if the phase correlation value of the first neighboring value of the two neighboring values is positive, and wherein the actual peak position is located between the peak location and a second neighboring value of the two neighboring values when in the third category and if the phase correlation value of the second neighboring value of the two neighboring values is positive.

In another aspect, an apparatus for implementing global motion estimation in a video comprises means for determining a global motion estimation using a common phase correlation approach, including determining a peak location, means for refining the global motion estimation by determining a sub-unit displacement at a sub-unit level using the peak location and two neighboring values, wherein refining the global motion estimation comprises determining a sub-unit displacement direction by examining signs of a peak phase correlation and two neighboring phase correlation values and determining a sub-unit displacement magnitude by applying a polynomial function and means for computing the global motion by adding the sub-unit displacement to the global motion estimation. Determining a sub-unit displacement direction by examining signs of the peak phase correlation and the two neighboring phase correlation values further comprises determining a category based on the signs of the peak phase correlation and the two neighboring phase correlation values. The category is selected from the group consisting of a first category, a second category and a third category, further wherein the first category includes a positive peak phase correlation and two negative neighboring phase correlation values, the second category includes a positive peak phase correlation and two positive neighboring phase correlation values, and the third category includes a positive peak phase correlation and a positive neighboring phase correlation value and a negative neighboring phase correlation value. An actual peak position is located at the peak location when in the first category. Alternatively, an actual peak position is located between the peak location and a first neighboring value of the two neighboring values when in the second category, if the phase correlation value of the first neighboring value of the two neighboring values is greater than a second neighboring value of the two neighboring values, and wherein the actual peak position is located between the peak location and the second neighboring value of the two neighboring values when in the second category, if the phase correlation value of the first neighboring value of the two neighboring values is less than the second neighboring value of the two neighboring values, and wherein the actual peak position is located at the peak location when in the second category, if the phase correlation value of the first neighboring value of the two neighboring values is equal to the second neighboring value of the two neighboring values. Alternatively, an actual peak position is located between the peak location and a first neighboring value of the two neighboring values when in the third category and if the phase correlation value of the first neighboring value of the two neighboring values is positive, and wherein the actual peak position is located between the peak location and a second neighboring value of the two neighboring values when in the third category and if the phase correlation value of the second neighboring value of the two neighboring values is positive.

In yet another aspect, a method of eliminating boundary effects in an image comprising adding a tail of data points to the image wherein the tail of data points gradually decreases to provide a smooth image boundary. The tail is represented by

$$tail ( x ) = \frac{f ( {x}_{b} )}{{( {x}_{b} - {x}_{0} )}^{3}} {( x - {x}_{0} )}^{3} ,$$

where f(x) is the image; x_{b} is the boundary of the image and x ∈[x₀, x_{b}].

### BRIEF DESCRIPTION OF THE DRAWINGS

FIG. 1 illustrates a chart representation of an image with a tail.

FIG. 2 illustrates a graphical representation of an exemplary peak in Category 1.

FIG. 3 illustrates a graphical representation of an exemplary peak in Category 2.

FIG. 4 illustrates a graphical representation of an exemplary peak in Category 3.

FIG. 5 illustrates a flowchart of a process of implementing high accurate subspace extension of phase correlation for global motion estimation.

FIG. 6 illustrates a block diagram of a device for implementing high accurate subspace extension of phase correlation for global motion estimation.

### DETAILED DESCRIPTION OF THE PREFERRED EMBODIMENT

When estimating video motion, there are two different kinds of motion: global motion and local motion. Global motion exists when acquiring video and the entire (global) video moves, such as when a user's hand shakes or when the user pans the video camera. Local motion on the other hand is when an object within an entire scene moves, such as a dog running in a park while the background of the grass and trees is relatively stationary.

To correct global motion which stems from a user's hand shaking or other movement with a video camera, motion estimation is implemented. Phase correlation is used for image registration between images, or in other words, phase correlation finds the difference between images. Thus, phase correlation is able to be applied for global motion estimation in video processing by determining the difference between images which corresponds to the movement between frames of a video. A common approach to phase correlation is described in a set of equations immediately below. By transforming to the frequency domain through phase correlation, a peak location is able to be determined.

Assuming images g₂(x,y)=g₁(x+dx,y+dy),

$$phase correlation surface S ( x , y ) = {J}^{- 1} \{ \frac{{G}_{1} ( u , v ) \cdot {{G}_{2} ( u , v )}^{*}}{\vert {G}_{1} ( u , v ) \vert \cdot \vert {G}_{2} ( u , v ) \vert} \} ,$$

where Gᵢ(u,v)=ℑ{gᵢ(x,y)},i=1,2. [symbol]
(dx, dy) [symbol] peak location of S(x,y)
The peak locations indicate movement in the video.

However, the accuracy of this approach is limited by the sample density of the images (e.g. the number of data points). Although interpolating data in either pixel domain or transform domain can increase data points and improve accuracy, it requires a significant amount of processing power.

To overcome the issue of too few data points, a number of approaches have been developed. One of the previous approaches is to increase data points on the phase correlation surface. By interpolating the phase surface in the frequency domain to sub-unit resolution, that increases the overall resolution. Another method includes applying a quadratic polynomial to fit the phase correlation plane in the spatial domain. Combining these two methods, interpolating the phase surface and applying a quadratic polynomial is also possible. It is then possible to locate the peak or peaks of the phase correlation surface to determine the picture displacement. The problem with this approach is that it increases the memory and data processing by several-fold.

Another approach is to approximate the phase correlation plane with combinations of the “sinc” function. The peak is located and then sub-unit displacement from the values of phase correlation in the neighborhood are derived. The formula is very simple if the peak is at the origin; however, the formula becomes very complicated when the peak is not at the origin. It is a function of peak location. Also, the accuracy drops if the displacement is not close to the sample grid or the middle of the sample grids.

Another concern that arises for the phase correlation approach is referred to as “boundary effects.” Boundary effects change the phase correlation plane and cause incorrect results. An approach called “windowing” has been used in the past to handle these boundary effects. Windowing is used to prevent boundary effects when performing the Fourier Transform. However, with windowing, by focusing too much on the center portion of the video due to data windowing, the part that is not in the center of the window is suppressed. This may cause problems in translational motion estimation such as tracking.

To overcome the issues described above, smooth boundary-dependent tails are attached around an image. The purpose of windowing is to avoid boundary effects, but as described above, it has many drawbacks. If tails are added, the original image is not changed. It is just the original image surrounded by smooth tails. The boundary effects are reduced or avoided.

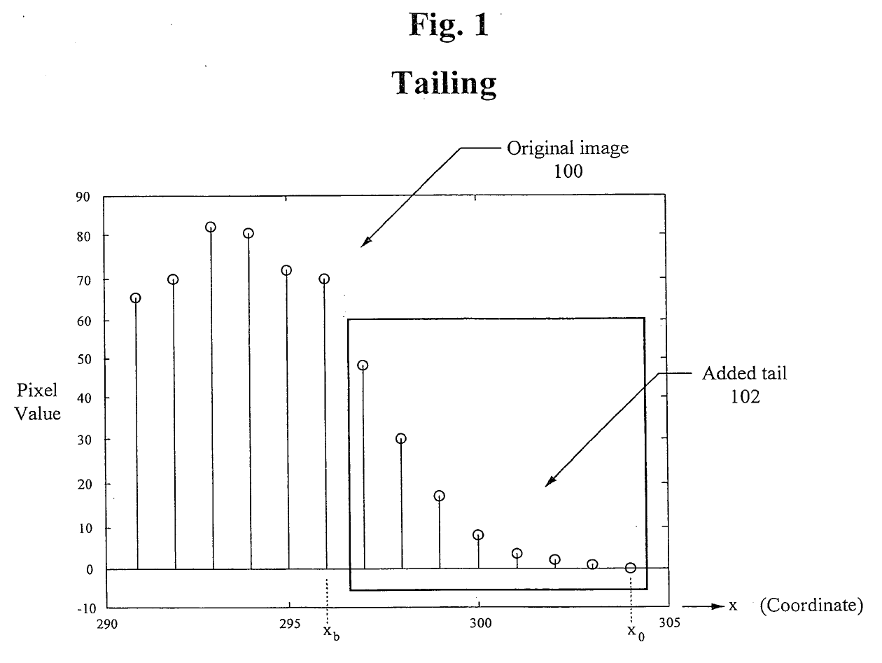

FIG. 1 illustrates a chart representation of an image with a tail. An original image with pixel values 100 is shown where its edge ends at a relatively high value. Without a tail, the pixel values would abruptly end at around 70 and then drop to 0. However, with an added tail 102, the values slowly decrease from 70 to 50, 30, 20, 10, 5 and eventually to 0. The result is an image with a much smoother boundary. Although additional points are added, the complexity of these points is minimal, and the tail does not have the drawbacks of previous methods preventing boundary effects.

A tail is described by the function:

$$tail ( x ) = \frac{f ( {x}_{b} )}{{( {x}_{b} - {x}_{0} )}^{3}} {( x - {x}_{0} )}^{3}$$

f(x) is the image
where x_{b} is the coordinate of the boundary of the image
x ∈[x₀,x_{b}]

Another aspect of high accurate subspace extension of phase correlation for global motion estimation is to refine sub-unit displacement directly based on the neighborhood values of phase correlation instead of interpolating the surface. After determining the rough peak locations with the common approach described above, the sub-unit refinement further pinpoints the location of the peaks which are utilized in motion estimation.

There are two components of sub-unit displacement: direction and magnitude. For direction, the signs of the peak and its two nearest neighbors are examined to determine the sub-unit displacement direction. For magnitude, the ratio of associated correlation values are applied to a 5^{th}-order polynomial function to determine the sub-unit displacement. By focusing the analysis on the peak and not the entire surface, computation time is saved, unlike previous approaches which interpolated the surface in the pixel or frequency domain. In the previous approaches, the peaks are discovered after generating the surface which requires a significant amount of sample data, thus a lot of memory and processing power. When implementing high accurate subspace extension of phase correlation for global motion estimation, the peak is found from the existing data point without doing an interpolation of a surface which saves memory and processing power.

There are four cases in three categories to determine the peak when looking at the sub-unit displacement based on direction. Table I shows the three categories and four cases while assuming a peak at P₀ with a phase correlation C₀.

TABLE I
Sub-Unit Displacement - Direction

| Category | C₋₁ | C₀ | C₁ | Actual Peak Position |
|---|---|---|---|---|
| 1 | − | + | − | P₀ |
| 2 | + | + | + | Between P₀ and P₋₁, if \|C₋₁\| > \|C₁\|; |
| | | | | Between P₀ and P₁, if \|C₋₁\| < \|C₁\|; |
| | | | | P₀, if \|C₋₁\| = \|C₁\|. |
| 3 | − | + | + | Between P₀ and P₁ |
| | + | + | − | Between P₀ and P₋₁ |

From Table I, Category 1 shows that when the first phase correlation, C₋₁, and the second phase correlation, C₁, are both negative (−) while the peak phase correlation, C₀, is positive (+), then the actual peak position is located at the position P₀. Category 2 shows that when all three phase correlations, C₋₁, C₀ and C₁, are positive, the actual peak position depends on the relationship between C₋₁ and C₁. If |C₋₁51 is greater than |C₁|, then the actual peak is between the position P₀ and the position P₋₁. If the |C₋₁| is less than |C₁|, then the actual peak is between the position P₀ and the position P₁. If |C₋₁|=|C₁|, then the actual peak is at the position P₀. Category 3 is split where C₀ is positive, but either C₋₁ is negative while C₁ is positive or C₋₁ is positive while C₁ is negative. If C₋₁ is negative while C₀ and C₁ are positive, then the actual peak is between the position P₀ and the position P₁. If C₁ is negative, while C₀ and C₋₁ are positive, then the actual peak is between the position P₀ and the position P₋₁.

After determining which category the data point is in for the sub-unit displacement direction, then a polynomial is used to determine the sub-unit displacement magnitude. From these the motion is able to be determined. The polynomial is described below.

Assuming motion parameter P_{actual}=P₀+Δ
P_{actual} is the actual motion
where P₀ is the estimated motion by phase correlation
Δ is the sub-unit displacement

$$⇒ \vert Δ \vert ≅ f ( \vert \frac{{C}_{i}}{{C}_{0}} \vert ) = {a}_{1} {\vert \frac{{C}_{i}}{{C}_{0}} \vert}^{5} + {a}_{2} {\vert \frac{{C}_{i}}{{C}_{0}} \vert}^{4} + {a}_{3} {\vert \frac{{C}_{i}}{{C}_{0}} \vert}^{3} + {a}_{4} {\vert \frac{{C}_{i}}{{C}_{0}} \vert}^{2} + {a}_{5} \vert \frac{{C}_{i}}{{C}_{0}} \vert , \qquad (* )$$

c₀ is the peak value of phase correlation

$$where {C}_{i} = \{ \begin{matrix}0 & Category 1 \\ {C}_{1} - {C}_{- 1} & Category 2 \\ {C}_{1} or {C}_{- 1} & Category 3\end{matrix}$$

Thus, actual motion of an image is able to be determined with very fine granularity by first determining rough data points using the common phase-correlation approach, then using the rough data points with a few neighboring data points to categorize the data points, and implementing the 5^{th} order polynomial function.

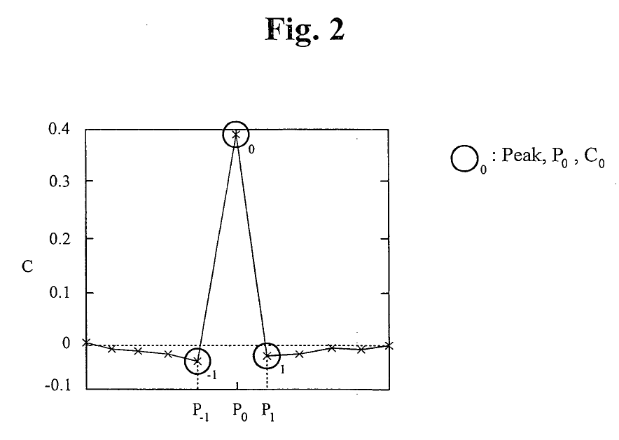

FIG. 2 illustrates a graphical representation of an exemplary peak in Category 1. As described above in Table I, when there is a peak where the other two phase correlations are negative, then the peak position Pₑₛₜᵢₘₐₜₑ equals the peak position P₀. In FIG. 2, C₀ is positive, roughly 0.4, and C₋₁ and C₁ are slightly negative, thus this peak falls in Category 1. Therefore, the estimated position of peak Pₑₛₜᵢₘₐₜₑ equals P₀.

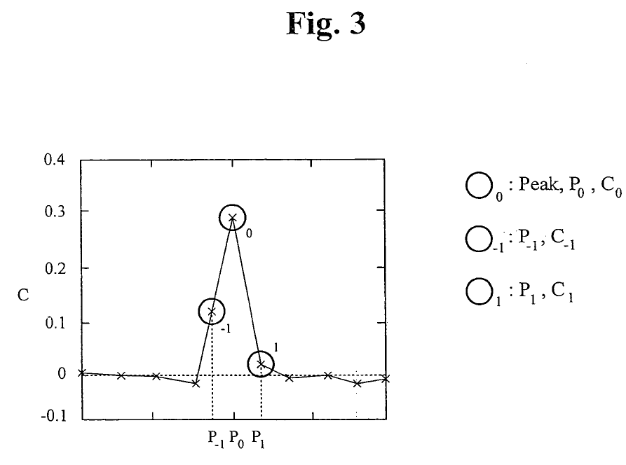

FIG. 3 illustrates a graphical representation of an exemplary peak in Category 2. When there is a positive peak with the two nearest neighbors also being positive, then the peak falls in Category 2. In the example of FIG. 3, C₀, C₋₁ and C₁ are all positive, at roughly 0.3, 0.1 and just above 0.0, respectively. Using Table 1 for Category 2 and the equation (*), it is determined that:

$${P}_{estimate} = {P}_{0} + [ f ( \vert \frac{{C}_{- 1}}{{C}_{0}} \vert ) - f ( \vert \frac{{C}_{1}}{{C}_{0}} \vert ) ] \cdot ( {P}_{- 1} - {P}_{0} )$$

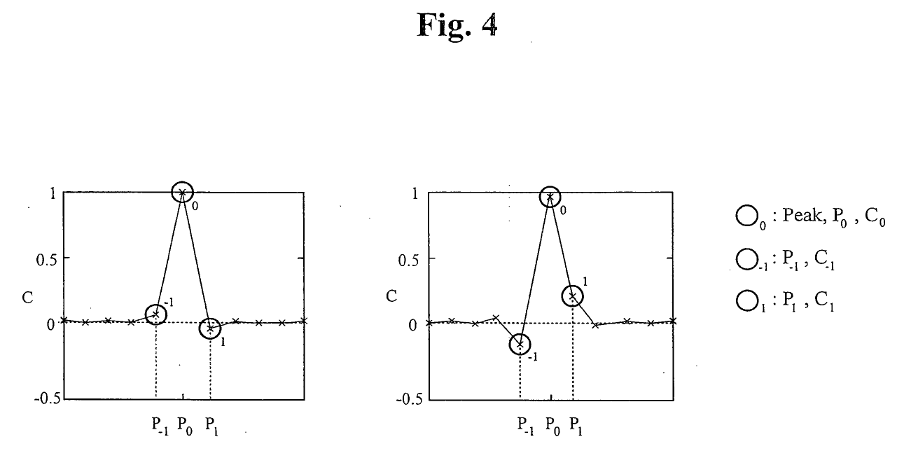

FIG. 4 illustrates a graphical representation of an exemplary peak in Category 3. When there is a positive peak and one of the nearest neighbors is positive while the other nearest neighbor is negative, then the peak falls in Category 3. In the left chart of FIG. 4, C₋₁ is just above zero (positive), while C₁ is just below zero (negative). In the right chart, C₋₁ is below zero (negative), while C₁ is above zero (positive). Using Table I for Category 3 and the equation (*) above, it is determined that:

$${P}_{estimate} = {P}_{0} + f ( \vert \frac{{C}_{- 1}}{{C}_{0}} \vert ) \cdot ( {P}_{- 1} - {P}_{0} ) ( For the left chart )$$

$${P}_{estimate} = {P}_{0} + f ( \vert \frac{{C}_{1}}{{C}_{0}} \vert ) \cdot ( {P}_{1} - {P}_{0} ) ( For the right chart )$$

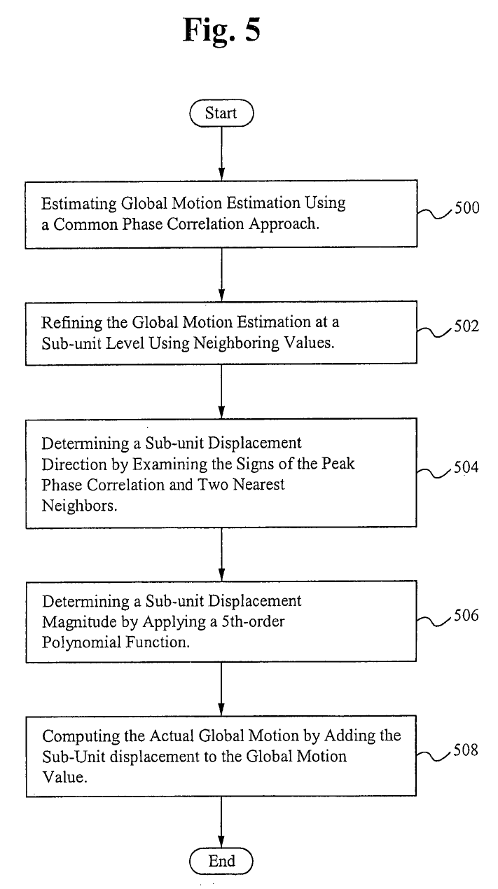

FIG. 5 illustrates a flowchart of a process of implementing high accurate subspace extension of phase correlation for global motion estimation. In the step 500, the global motion estimation is estimated using a common phase-correlation approach. In the step 502, the global motion estimation is refined at a sub-unit level using the peak and neighboring values. The refinement process includes determining the sub-unit displacement direction (the step 504) and the sub-unit displacement magnitude (the step 506). In the step 504, the sub-unit displacement direction is determined by examining the signs of the peak phase correlation and the two nearest neighbors. Examining the signs of the peak phase correlation and the two nearest neighbors includes utilizing categories which determine where the actual peak is. The categories vary based on the signs of the peak phase correlation and the two nearest neighbors such that category 1 is where the peak phase correlation is positive, while the neighbors are negative; category 2 is where all three phase correlations are positive and category 3 is where the peak phase correlation is positive and only one of the neighbors is positive while the other is negative. In the step 506, the sub-unit displacement magnitude is determined by applying a ratio of associated phase correlation values to a 5^{th}-order polynomial function. The actual motion is then computed by adding the sub-unit displacement, including the direction and magnitude, to the global motion estimation value, in the step 508.

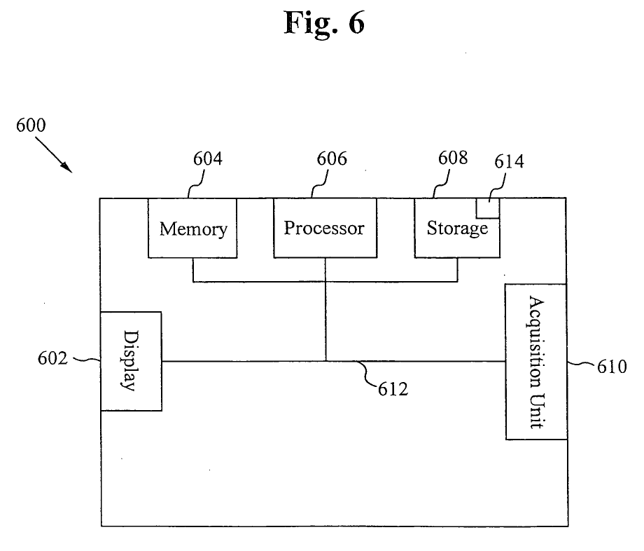

FIG. 6 illustrates a block diagram of a device for implementing high accurate subspace extension of phase correlation for global motion estimation. A computing device 600 includes a number of elements: a display 602, a memory 604, a processor 606, a storage 608, an acquisition unit 610 and a bus 612 to couple the elements together. The acquisition unit 610 acquires video data which is then processed by the processor 606 and temporarily stored on the memory 604 and more permanently on the storage 608. The display 602 displays the video data acquired either during acquisition or when utilizing a playback feature. When the global motion estimation described herein is implemented in software, an application 614 resides on the storage 608, and the processor 606 processes the necessary data while the amount of the memory 604 used is minimized. When implemented in hardware, additional components are utilized to process the data. The computing device 600 is able to be, but is not limited to, a digital camcorder, a digital camera, a cellular phone, PDA or a computer.

To utilize high accurate subspace extension of phase correlation for global motion estimation, a user does not perform any additional functions. The high accurate subspace extension of phase correlation for global motion estimation is automatically implemented so that a user experiences a video with minimal or no global motion. After using a common global motion estimation approach to obtain data points, a refinement process is implemented to more accurately estimate the motion. Phase correlations of peak points and their neighbors are categorized to determine the displacement direction, and then a polynomial function is used to determine the magnitude of the displacement. Then, these results are used to calculate the actual motion.

Additionally, tailing is able to be implemented to ensure the image does not have boundary effects issues.

In operation, high accurate subspace extension of phase correlation for global motion estimation is able to estimate global motion while balancing computational load and accuracy. There is no need to interpolate the phase correlation surface; rather, displacement is directly estimated from phase correlation coefficients. Therefore, a significantly less amount of memory and processing power is utilized while accurately estimating global motion. Also, by utilizing tailing, better handling of pictures with local motion is possible because the entire image data is used instead of the central part of an image by simply applying a windowing process.

High accurate subspace extension of phase correlation for global motion estimation is able to be implemented in software, hardware or a combination of both.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of refining global motion estimation comprising:
a. determining a sub-unit displacement direction by examining signs of a peak phase correlation and two neighboring phase correlation values; and
b. determining a sub-unit displacement magnitude by applying a polynomial function.

2. The method as claimed in claim 1 wherein determining a sub-unit displacement direction by examining signs of the peak phase correlation and the two neighboring phase correlation values further comprises determining a category based on the signs of the peak phase correlation and the two neighboring phase correlation values.

3. The method as claimed in claim 2 wherein the category is selected from the group consisting of a first category, a second category and a third category, further wherein the first category includes a positive peak phase correlation and two negative neighboring phase correlation values, the second category includes a positive peak phase correlation and two positive neighboring phase correlation values, and the third category includes a positive peak phase correlation and a positive neighboring phase correlation value and a negative neighboring phase correlation value.

4. The method as claimed in claim 3 wherein an actual peak position is located at a peak location when in the first category.

5. The method as claimed in claim 3 wherein an actual peak position is located between a peak location and a first neighboring value of the two neighboring values when in the second category, if the phase correlation value of the first neighboring value of the two neighboring values is greater than a second neighboring value of the two neighboring values, and wherein the actual peak position is located between the peak location and the second neighboring value of the two neighboring values when in the second category, if the phase correlation value of the first neighboring value of the two neighboring values is less than the second neighboring value of the two neighboring values, and wherein the actual peak position is located at the peak location when in the second category, if the phase correlation value of the first neighboring value of the two neighboring values is equal to the second neighboring value of the two neighboring values.

6. The method as claimed in claim 3 wherein an actual peak position is located between a peak location and a first neighboring value of the two neighboring values when in the third category and if the phase correlation value of the first neighboring value of the two neighboring values is positive, and wherein the actual peak position is located between the peak location and a second neighboring value of the two neighboring values when in the third category and if the phase correlation value of the second neighboring value of the two neighboring values is positive.

7. A method of estimating global motion in a video comprising:
a. determining a global motion estimation using a common phase correlation approach, including determining a peak location;
b. refining the global motion estimation by determining a sub-unit displacement at a sub-unit level using the peak location and two neighboring values, wherein refining the global motion estimation comprises:
i. determining a sub-unit displacement direction by examining signs of a peak phase correlation and two neighboring phase correlation values; and
ii. determining a sub-unit displacement magnitude by applying a polynomial function; and
c. computing the global motion by adding the sub-unit displacement to the global motion estimation.

8. The method as claimed in claim 7 wherein determining a sub-unit displacement direction by examining signs of the peak phase correlation and the two neighboring phase correlation values further comprises determining a category based on the signs of the peak phase correlation and the two neighboring phase correlation values.

9. The method as claimed in claim 8 wherein the category is selected from the group consisting of a first category, a second category and a third category, further wherein the first category includes a positive peak phase correlation and two negative neighboring phase correlation values, the second category includes a positive peak phase correlation and two positive neighboring phase correlation values, and the third category includes a positive peak phase correlation and a positive neighboring phase correlation value and a negative neighboring phase correlation value.

10. The method as claimed in claim 9 wherein an actual peak position is located at the peak location when in the first category.

11. The method as claimed in claim 9 wherein an actual peak position is located between the peak location and a first neighboring value of the two neighboring values when in the second category, if the phase correlation value of the first neighboring value of the two neighboring values is greater than a second neighboring value of the two neighboring values, and wherein the actual peak position is located between the peak location and the second neighboring value of the two neighboring values when in the second category, if the phase correlation value of the first neighboring value of the two neighboring values is less than the second neighboring value of the two neighboring values, and wherein the actual peak position is located at the peak location when in the second category, if the phase correlation value of the first neighboring value of the two neighboring values is equal to the second neighboring value of the two neighboring values.

12. The method as claimed in claim 9 wherein an actual peak position is located between the peak location and a first neighboring value of the two neighboring values when in the third category and if the phase correlation value of the first neighboring value of the two neighboring values is positive, and wherein the actual peak position is located between the peak location and a second neighboring value of the two neighboring values when in the third category and if the phase correlation value of the second neighboring value of the two neighboring values is positive.

13. An apparatus for implementing global motion estimation in a video comprising:
a. a determining module for determining a global motion estimation using a common phase correlation approach, including determining a peak location;
b. a refining module for refining the global motion estimation by determining a sub-unit displacement at a sub-unit level using the peak location and two neighboring values, wherein refining the global motion estimation comprises:
i. determining a sub-unit displacement direction by examining signs of a peak phase correlation and two neighboring phase correlation values; and
ii. determining a sub-unit displacement magnitude by applying a polynomial function; and
c. a computing module for computing the global motion by adding the sub-unit displacement to the global motion estimation.

14. The apparatus as claimed in claim 13 wherein determining a sub-unit displacement direction by examining signs of the peak phase correlation and the two neighboring phase correlation values further comprises determining a category based on the signs of the peak phase correlation and the two neighboring phase correlation values.

15. The apparatus as claimed in claim 14 wherein the category is selected from the group consisting of a first category, a second category and a third category, further wherein the first category includes a positive peak phase correlation and two negative neighboring phase correlation values, the second category includes a positive peak phase correlation and two positive neighboring phase correlation values, and the third category includes a positive peak phase correlation and a positive neighboring phase correlation value and a negative neighboring phase correlation value.

16. The apparatus as claimed in claim 15 wherein an actual peak position is located at the peak location when in the first category.

17. The apparatus as claimed in claim 15 wherein an actual peak position is located between the peak location and a first neighboring value of the two neighboring values when in the second category, if the phase correlation value of the first neighboring value of the two neighboring values is greater than a second neighboring value of the two neighboring values, and wherein the actual peak position is located between the peak location and the second neighboring value of the two neighboring values when in the second category, if the phase correlation value of the first neighboring value of the two neighboring values is less than the second neighboring value of the two neighboring values, and wherein the actual peak position is located at the peak location when in the second category, if the phase correlation value of the first neighboring value of the two neighboring values is equal to the second neighboring value of the two neighboring values.

18. The apparatus as claimed in claim 15 wherein an actual peak position is located between the peak location and a first neighboring value of the two neighboring values when in the third category and if the phase correlation value of the first neighboring value of the two neighboring values is positive, and wherein the actual peak position is located between the peak location and a second neighboring value of the two neighboring values when in the third category and if the phase correlation value of the second neighboring value of the two neighboring values is positive.

19. An apparatus for implementing global motion estimation in a video comprising:
a. means for determining a global motion estimation using a common phase correlation approach, including determining a peak location;
b. means for refining the global motion estimation by determining a sub-unit displacement at a sub-unit level using the peak location and two neighboring values, wherein refining the global motion estimation comprises:
i. determining a sub-unit displacement direction by examining signs of a peak phase correlation and two neighboring phase correlation values; and
ii. determining a sub-unit displacement magnitude by applying a polynomial function; and
c. means for computing the global motion by adding the sub-unit displacement to the global motion estimation.

20. The apparatus as claimed in claim 19 wherein determining a sub-unit displacement direction by examining signs of the peak phase correlation and the two neighboring phase correlation values further comprises determining a category based on the signs of the peak phase correlation and the two neighboring phase correlation values.

21. The apparatus as claimed in claim 20 wherein the category is selected from the group consisting of a first category, a second category and a third category, further wherein the first category includes a positive peak phase correlation and two negative neighboring phase correlation values, the second category includes a positive peak phase correlation and two positive neighboring phase correlation values, and the third category includes a positive peak phase correlation and a positive neighboring phase correlation value and a negative neighboring phase correlation value.

22. The apparatus as claimed in claim 21 wherein an actual peak position is located at the peak location when in the first category.

23. The apparatus as claimed in claim 21 wherein an actual peak position is located between the peak location and a first neighboring value of the two neighboring values when in the second category, if the phase correlation value of the first neighboring value of the two neighboring values is greater than a second neighboring value of the two neighboring values, and wherein the actual peak position is located between the peak location and the second neighboring value of the two neighboring values when in the second category, if the phase correlation value of the first neighboring value of the two neighboring values is less than the second neighboring value of the two neighboring values, and wherein the actual peak position is located at the peak location when in the second category, if the phase correlation value of the first neighboring value of the two neighboring values is equal to the second neighboring value of the two neighboring values.

24. The apparatus as claimed in claim 21 wherein an actual peak position is located between the peak location and a first neighboring value of the two neighboring values when in the third category and if the phase correlation value of the first neighboring value of the two neighboring values is positive, and wherein the actual peak position is located between the peak location and a second neighboring value of the two neighboring values when in the third category and if the phase correlation value of the second neighboring value of the two neighboring values is positive.

25. A method of eliminating boundary effects in an image comprising adding a tail of data points to the image wherein the tail of data points gradually decreases to provide a smooth image boundary.

26. The method as claimed in claim 25 wherein the tail is represented by
$$tail ( x ) = \frac{f ( {x}_{b} )}{{( {x}_{b} - {x}_{0} )}^{3}} {( x - {x}_{0} )}^{3} ,$$
where f(x) is the image; x_{b} is the boundary of the image and x ∈[x₀,x_{b}].
